(19) United States
(12) Patent Application Publication
(10) Pub. No.: US 2010/0209594 A1
(43) Pub. Date: Aug. 19, 2010

(54) PRINTING ALUMINUM FILMS AND PATTERNED CONTACTS USING ORGANOMETALLIC PRECURSOR INKS

(75) Inventors: Calvin J. Curtis, Lakewood, CO (US); Alexander Miedaner, Boulder, CO (US); Marinus Franciscus Antonius Maria van Hest, Lakewood, CO (US); David S. Ginley, Evergreen, CO (US)

Correspondence Address: PAUL J WHITE, PATENT COUNSEL;NATIONAL RENEWABLE ENERGY LABORATORY (NREL), 1617 COLE BOULEVARD, MS 1734, GOLDEN, CO, 80401-3393, US

(73) Assignee: Alliance for Sustainable Energy, LLC, Golden, CO (US)

(21) Appl. No.: 12/678,647

(22) PCT Filed: Nov. 3, 2008
(86) PCT No.: PCT/US08/82195

§ 371 Date: Mar. 17, 2010

Related U.S. Application Data
(60) Provisional application No. 60/984,825, filed on Nov. 2, 2007.

(51) Int. Cl. B05D 5/12

(52) U.S. Cl. 427/74; 427/123

(57) ABSTRACT

A method (200) for depositing an aluminum film or contact (124). The method includes providing (230) a substrate (120) with a surface for receiving the aluminum film (124). The substrate (120) is heated (240) to a printing temperature such as over 150° C., and the method (200) includes depositing (250) a volume of ink upon a surface of the substrate (120). The ink (136) includes an organometallic aluminum complex or precursor, and the substrate surface temperature is selected or high enough to decompose the organometallic aluminum complex or precursor to provide aluminum of the film (124) and a gaseous byproduct. The depositing or printing (250) of the ink may be performed within an inert or substantially oxygen-free atmosphere (144). The ink (136) may be a solution of the organometallic aluminum complex and a solvent. The aluminum complex or precursor may include an amine compound and alane.

### CROSS-REFERENCE TO RELATED APPLICATIONS

This application claims the benefit of U.S. Provisional Application No. 60/984,825, filed Nov. 2, 2007, which is incorporated herein by reference in its entirety.

### CONTRACTUAL ORIGIN

The United States Government has rights in this invention under Contract No. DE-AC36-08GO28308 between the United States Department of Energy and the Alliance for Sustainable Energy, LLC, the Manager and Operator of the National Renewable Energy Laboratory.

### BACKGROUND

There has been explosive growth in the demand for electronic devices fabricated with thin metal films and patterned metallic layers or components. These films and metallic components may be used to provide contacts in solar cells, to provide circuits for electronic devices such as computers and cellular phones, to provide flexible electronics, and to serve other needs. As a result, there is a rapidly growing desire by the electronics industry to lower the costs of manufacturing while maintaining or even improving the functionality of these electronic devices. For example, a key area of expected improvement in the area of photovoltaic cells is the development of low-cost, materials-efficient fabrication processes.

In recent years, there has been increased interest and experimentation in the use of direct-write technologies such as inkjet printing to provide contacts, printed circuits, flexible electronic components, and other electronic devices. Direct-write techniques such as inkjet printing are desirable because a printed pattern such as a circuit or patterned contacts for a solar cell can be printed in a single step without the use of masks and further processing steps as is typically the case with vacuum and other deposition methods. Direct-write techniques or printing of metal layers (sometimes referred to as “metallizations”) also provides the advantages of low capitalization (e.g., no reaction chamber typically required), very high materials efficiency, elimination of the need for photolithography, and non-contact processing.

Conceptually, for silicon (Si) solar cells, all device elements except the silicon substrate could be directly written or printed including contact metallizations (e.g., front and rear contacts), dopants, transparent conductors, and antireflection coatings. Initial efforts have concentrated on providing techniques for developing contact metallizations. A major challenge in applying inkjet and other printing processes to the area of direct writing is the formulating of suitable inks. The inks typically need to contain the appropriate metal precursors and a carrier vehicle such as a solvent. In addition, the metal precursor may contain various binders, dispersants, and adhesion promoters depending on the nature of the precursor and the particular application. In the case of inks being used for metallization, the content of the metallic ink may need to be adjusted to provide the required resolution with good adhesion and desired electronic properties for the conducting lines, contacts, or circuit. With these requirements in mind, researchers have provided direct-write contacts for Si solar cells with metallizations of silver, (Ag), copper (Cu), and nickel (Ni). For example, inkjet printing with Ag, Cu, and Ni inks is described U.S. Patent Publication No. 2008/0003364, which is incorporated herein by reference.

To date, though, these printing methodologies have been limited to providing the n contacts for a Si solar cell and there has been little discussion in the research literature for methods of using direct write metal inks for providing the p contact of a Si solar cell. Printing of both contacts of a solar cell would significantly improve manufacturing processes by, for example, facilitating lower pressure deposition and reducing post-deposition processing. Further, printing the metal ink in a pattern allows cells to be designed with interdigitized contacts (intertwined p and n contacts) on a single side of a solar cell rather than requiring front and back contacts on opposite sides of the Si substrate, which can result in blocking of the light and reduced cell efficiencies.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods that are meant to be exemplary and illustrative, not limiting in scope. In various embodiments, one or more of the above-described problems have been reduced or eliminated, while other embodiments are directed to other improvements.

In one embodiment, a method is provided for depositing a film of aluminum such as a contact, circuit, or layer. The method includes providing a substrate with a surface for receiving the aluminum film The surface of the substrate is heated to a printing temperature, and the method includes depositing a volume of ink upon the surface of the substrate. The ink includes an organometallic aluminum complex or precursor of aluminum, and the printing or substrate surface temperature is selected or high enough to decompose the organometallic aluminum complex or precursor to provide aluminum of the film and a gaseous byproduct. The printing temperature may be greater than about 140° C. in some cases such as in the range of about 150 to 200° C. or higher. The depositing or printing of the ink may be performed within an inert or substantially oxygen-free atmosphere (e.g., an argon or nitrogen atmosphere) and at ambient pressure (e.g., at about 1 atm) as vacuum is not required. The ink may be a solution of the organometallic aluminum complex and a solvent, which provides a viscosity of less than about 250 centipoise. The aluminum complex or precursor may include an amine compound and alane and/or another aluminum compound. The ink may be deposited using an inkjet printer, by spin or dip coating, using spray deposition, by stamping techniques, or direct writing methods. The substrate in one embodiment is a Si solar cell substrate and the aluminum film provides a contact for the cell substrate, and in another embodiment, the method includes printing an additional metal contact (such as direct writing a silver pattern) on for the solar cell upon the surface of the substrate, with the aluminum contact and additional contact being patterned as interdigitated contacts. The ability to print AL and other metal patterns is useful for producing contacts to other types of solar cells as well, including CIGS, CdTe, and organic photovoltaic (OPV) device structures.

In addition to the exemplary aspects and embodiments described above, further aspects and embodiments will become apparent by reference to the drawings and by study of the following descriptions.

### BRIEF DESCRIPTION OF THE DETAILED DRAWINGS

Exemplary embodiments are illustrated in referenced figures of the drawings. It is intended that the embodiments and figures disclosed herein are to be considered illustrative rather than limiting.

FIG. 1 illustrates schematically a print or deposition system adapted for depositing an aluminum layer or pattern using an aluminum precursor ink including an organometallic aluminum complex;

FIG. 2 illustrates a direct writing or printing process for forming a layer or pattern (a “metallization”) of aluminum at ambient pressures;

FIG. 3 illustrates an X-ray diffraction (XRD) scan of an exemplary aluminum film deposited upon a substrate heated to about 200° C. using organometallic ink, such as may be provided by the system of FIG. 1 performing the method of FIG. 2;

FIG. 4 is a side view of a silicon solar cell structure with interdigitated or interdigital n and p contacts including at least one set of contacts printed with ink including an organometallic aluminum complex (e.g., the p contact of an Si solar cell);

FIG. 5 illustrates a top view of the solar cell structure of FIG. 4 illustrating the printed pattern providing the interdigitated contacts on a single surface of the cell; and

FIG. 6 illustrates another solar cell embodiment with spaced-apart rear and front contacts printed on opposite sides of the cell (e.g., an Al rear metal contact and an Ag front contact printed in a pattern or patterned with post-printing processing).

### DESCRIPTION

The following provides a description of organometallic ink-based printing processes and systems for deposition of aluminum (Al) metallizations for solar cell/photovoltaic device contacts and other electronic device components such as printed circuits on flexible plastic substrates. The printing process is facilitated by selection of an ink or writable precursor to aluminum for use in contacts or other deposited layers. Aluminum is very reactive, and, with this in mind, the ink is chosen to be stable (e.g., not necessarily highly volatile) but yet to decompose at relatively low temperature to the desired metal. Typically, it is difficult to get adequately pure aluminum because compounds with aluminum often react too rapidly and form aluminum oxide. The printing processes described herein address that problem by providing an ink that is a solution of an organometallic aluminum complex in an organic solvent (such as an ether, an aromatic solvent, and the like) to provide a relatively low viscosity ink useful in printing processes such as inkjet printing, spin/dip coating, spray deposition, and other printing techniques. The ink is printed onto a substrate such as a solar cell substrate or the like heated to a high enough temperature (e.g., above 140° C.) such that the ink or molecular compound used as the ink decomposes to aluminum and a number of volatile byproducts, which are released leaving a deposited layer or pattern (a “metallization”) of aluminum on the substrate. The printing may be performed at ambient pressures such as atmospheric pressure (e.g., at about 1 atm or 1 bar). The direct write and/or printing processes described may be used for printed Al films, printing lines and shapes, depositing Al in patterns such as interdigitated contacts, and so on. The printing processes may be implemented in a production line or other continuous process or in other manufacturing applications. These and other exemplary embodiments may be better understood with reference to the following discussion.

The development of direct write metals is of increasing interest for contacts or metallizations for solar cells, printed circuits, catalysis, flexible electronics, and other used in the electronics and other industries. The inventors understood that it would be beneficial in many settings to provide aluminum metallizations such as for contacts (e.g., the p contact of a Si solar cell), but that there was almost no literature or writings on direct writing using aluminum. The inventors also understood that thin films of aluminum or metallizations were presently being formed using metal-organic (MO) chemical vapor deposition (MOCVD), but this process required providing a vacuum and use of other processes to obtain patterns such as interdigitated contacts. MOCVD is also a relatively expensive fabrication process.

The inventors determined that aluminum may be printed upon a heated substrate at ambient pressure (e.g., vacuum is not required) and in an inert atmosphere. To this end, an ink was selected that includes an organometallic aluminum complex in a compatible organic solvent. It was determined that the organometallic aluminum complex decomposes at relatively low temperatures such as temperatures greater than about 140° C., which makes it well suited for printing on a range of substrates including solar cell substrates, glass, ceramics, and even many plastics (e.g., plastics used in flexible electronic devices that can withstand temperatures up to about 300° C.). Decomposition occurs at ambient pressures, and the purity of the Al metallization is enhanced by providing an inert or oxygen-free atmosphere at the surface of the substrate upon which the ink is printed. Complexes developed as volatile precursors for vacuum deposition of Al using MOCVD or metal organic vapor phase epitaxy (MOVPE) may be used in the ink to provide the organometallic aluminum complex or Al source. For example, amine coordination complexes of aluminum hydrides, such as alane (AlH₃), have been proven to work well in the direct-write ink as the organometallic Al source. Other organometallic aluminum complexes may be used for ink precursors such as aluminum alkyls (e.g., Et₃Al), mixed alkyl hydride complexes (e.g., Bu₂AlH), and amine coordination complexes thereof.

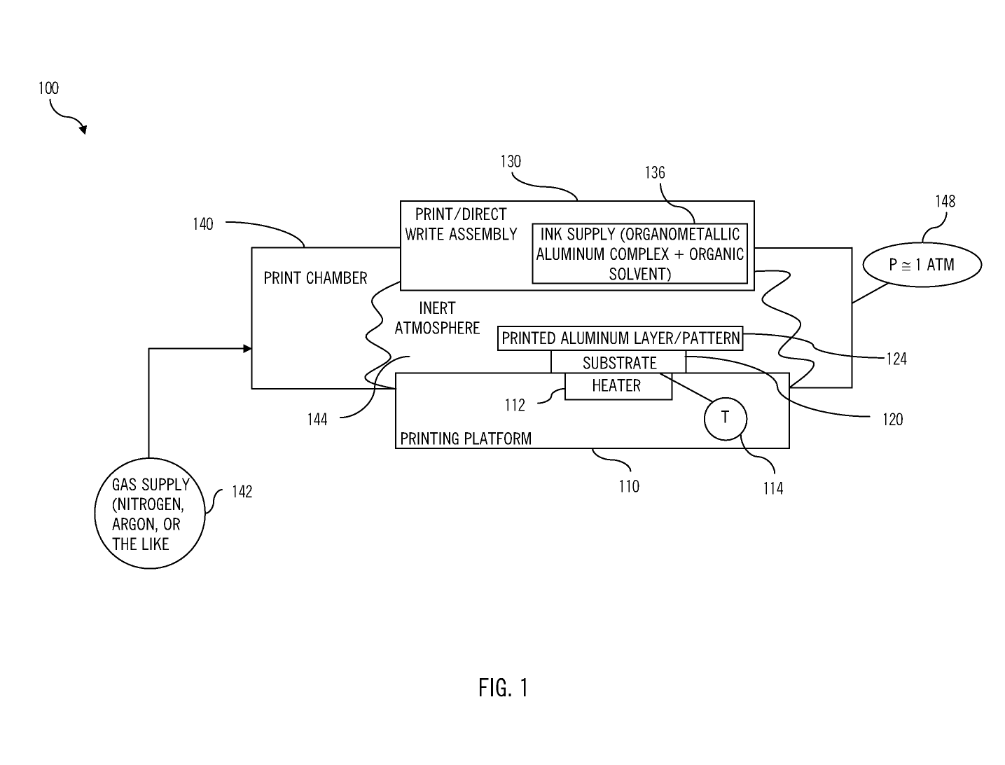

FIG. 1 illustrates one embodiment of a printing system 100 used for direct writing layers or patterns of Al on a substrate using ink with an organometallic aluminum complex. The print system 100 includes a printing platform (or part positioning device) 110 upon which a substrate or part 120 is positioned such as a Si substrate for a solar cell or a flexible sheet for a flexible electronics component. The platform 110 includes a heater 112 (or heating may be accomplished in other manners), and temperature sensor 114 is provided to indicate when the substrate 120 has been heated to a desired printing temperature. For example, the printing temperature may be a temperature selected based on the particular ink formulation to cause the organometallic aluminum complex to decompose to aluminum and a volatile byproduct. For example, it is likely that a temperature of at least about 140° C. may be useful with many ink formulations while temperatures up to 200° C. or more may be useful in some cases with the upper temperature being limited only by the material of the substrate such as less than about 300° C. with some plastic substrates but higher temperatures are acceptable for some glass or ceramic substrates (e.g., a range of about 140 to 300° C. or higher may be used in some embodiments of system 100). In some cases, the sensor 114 may not be used and the substrate 120 may simply be placed upon a heated surface above/on heater 112 for a predetermined length of time to heat the substrate 120 to the print temperature.

The system 100 also includes a print/direct write assembly 130 with an ink supply or source 136 for the printing process/components, which may include an inkjet printer, a spray deposition mechanism, a stamping device, or the like. The printing assembly 130 is operable to print a volume of ink from the ink supply 136 onto the substrate 120 surface as shown as printed Al layer and/or pattern (i.e., metallization) 124. To improve the purity of the aluminum in metallization 124, the printing is performed in a chamber 140 (or other arrangement to provide the desired atmosphere). The print atmosphere 144 at or near the surface of the substrate 120 is maintained inert or substantially oxygen free such as via use of a gas supply 142 that provides a nitrogen, argon, or other gas in chamber 140 to provide the inert atmosphere 144. The printing by assembly 130 is typically performed at or near ambient pressure as is shown with pressure gauge 148 having a reading of about 1 atmosphere or 1 bar. The ink provided by ink supply 136 is typically a solution of an organometallic aluminum complex in an organic solvent such as an ether, an aromatic, or the like. The solvent generally is used to define or set the viscosity of the ink, and the printing of layer/pattern 124 is enhanced via use of a relatively low viscosity ink such as one with a viscosity of less than about 250 centipoise (e.g., in the range of 1 to 250 centipoise).

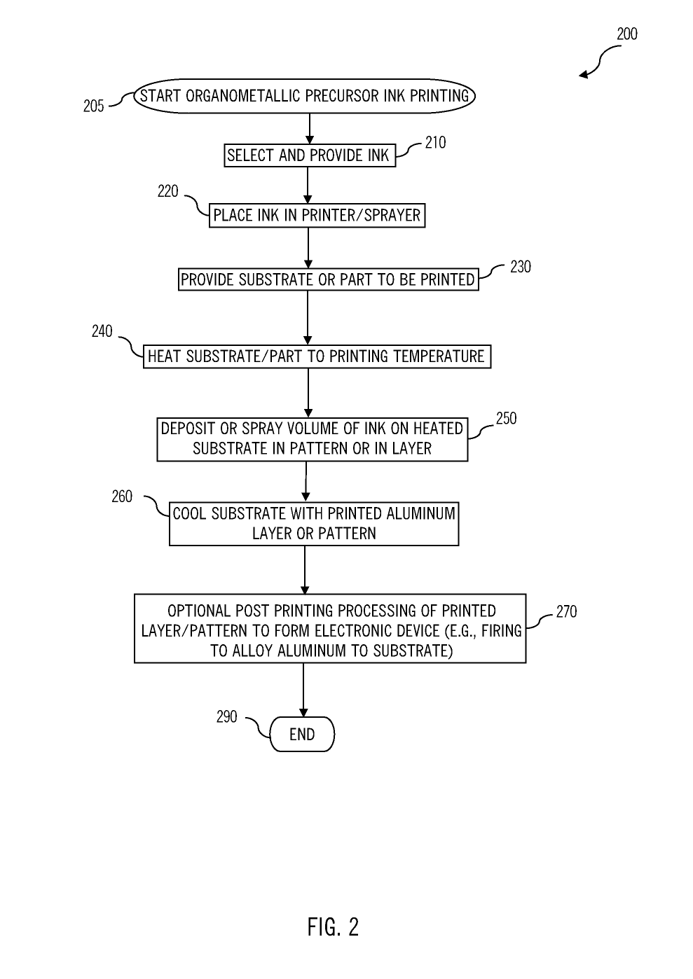

FIG. 2 illustrates a printing process 200 for providing a metallization of substantially pure aluminum on a surface of a substrate or part, and the system 100 of FIG. 1 may be operated to perform the process 200 to create metallized part 120 (e.g., an Si solar cell with interdigitated contacts 124 or the like). The method 200 begins at 205 such as with choosing a printing methodology for direct writing/printing an Al metallization and creating a pattern for the metallization for a particular electronic component (e.g., a flexible electronic component, a solar cell, or the like). Again, a variety of printing methods to provide a printed film or pattern with inks described herein such as spray deposition, spin/dip coating, inkjet printing, printer press-type printing (e.g., flexography, gravure printing, and so on), stamping, and other printing operations that may be useful for applying ink in a relative thin film or in a pattern. At 210, the method 200 continues with selecting and providing the ink, and the ink is chosen to include a precursor for Al (such as by including an aluminum alkyl or an amine compound of alane or another organometallic aluminum complex).

At 220, the ink is placed in a printer/sprayer or otherwise made available for use by one or more printing devices or components. At 230, the substrate or part that is to be printed upon is provided (e.g., positioned relative to the printer's ink outlet to received sprayed/discharged ink). At 240, the method 200 continues with heating the substrate or part (or the ink-receiving surface) to a printing temperature or to a temperature within a print temperature range (e.g., a temperature between 140 and 300° C. or other temperature chosen to assure decomposition of the Al precursor within a desired timeframe). At 250, the inkjet printer or other printing/spraying device is operated to deposit, spray, print, or stamp a volume of the ink on the heated surface of the substrate, and the volume of ink typically is deposited as a film or layer of metal that covers an entire surface or is arranged in a predefined print pattern (e.g., a desired shape for a device contact such as an interdigitated contact for a solar cell or another pattern for a solar cell or other part).

During step 250 (or soon after the printing as the part may be held at the raised temperature for a predefined decomposition or post-printing time period), the molecular compound of the precursor or complex within the ink decomposes to aluminum and volatile byproducts (which are released as a gas). At 260, the printed part or substrate is cooled to provide a component with an Al layer or metallization that is substantially air stable, e.g., ready for use or further processing. At 270, the method 200 continues with optional post-printing processing of the printed layer/pattern. This processing 270 may include firing to alloy the aluminum to the substrate as may be desirable when the metallization is a contact of a Si solar cell (e.g., alloy the aluminum layer to the silicon substrate using temperature spikes such as to 650 to 1000° C. or the like). The printing process 200 ends at 290 and the metallized substrate or part may be used as a standalone component/product or provided as one part of a larger assembly or electronic device (e.g., flexible electronics in a cell phone, a single solar cell in an array of cells, and so on).

As discussed above, the metal precursor or ink contains an amine compound and aluminum hydride (AlH₃ or alane) (e.g., an organometallic aluminum complex) and also contains an organic solvent. The concentration of the aluminum precursor in the solvent is preferably between 1 and 50 weight percent. The amine compound may be a monoamine or a polyamine compound such as a diamine or triamine. The monoamine compound can be represented by the formula NR1R2R3. Specific examples of R1, R2, and R3 in this formula include: alkyl groups such as methyl, ethyl, propyl, butyl, pentyl, hexyl, heptyl, octyl, nonyl, decyl, undecyl and dodecyl; cyclic alkyl groups such as cyclopentyl and chclohexyl; and aryl groups such as phenyl, benzyl, tolyl, xylyl, mesityl and naphthyl.

Specific examples of monoamines represented by NR1R2R3 include trimethylamine, triethylamine, tri-n-propylamine, triisopropylamine, tri-n-butylamine, triisobutylamine, tri-sec-butylamine, tri-n-pentylamine, tri-n-hexylamine, tricyclohexylamine, trioctylamine, triphenylamine, tribenzylamine, dimethylphenylamine, diethylphenylamine, methyldiphenylamine, ethyldiphenylamine, dimethylethylamine, and diethylmethylamine. Specific examples of polyamine compounds include ethylenediamine, sym- and asym-dimethylethylenediamine, diethylenetriamine and triethylenetetramine.

Although amine-alane complexes are one preferred Al precursor, other aluminum compounds can be used in combination with amine-alane complexes or by themselves as precursors to Al films. Examples of other useful aluminum compounds or organometallic aluminum complexes include trimethylaluminum, triethylaluminum, tri-n-propylaluminum, tri-n-butylaluminum, tri-t-butylaluminum, triphenylaluminum, tribenzylaluminum, diethylaluminum hydride, diisobutylaluminum hydride, diphenylaluminum hydride, and monoamine complexes of these compounds.

To form a printable ink, these aluminum precursors are dissolved in a solvent, which defines a viscosity (e.g., less than about 250 centipoise or the like). The solvent used is not particularly limited and may be any solvent that will dissolve the complex but does not react with the complex such as an organic solvent that provides ink when mixed with the Al precursor in a liquid phase at room temperature. These solvents would include hydrocarbon and ether solvents, other solvents that do not contain unsaturated functional groups (e.g., acids, esters, aldehydes, ketones, nitriles, and the like), and other solvents as those that contain acidic hydrogens. Examples of suitable solvents include, but are not limited to: (a) hydrocarbon solvents such as pentane, hexane, cyclohexane, heptane, octane, benzene, toluene, xylene, and mesitylene; and (b) ether solvents such as diethylether, dibutylether, ethylene glycol dimethylether, diethylene glycol dimethylether, tetrahydrofuran, and p-dioxane.

In one test embodiment of the method 200, the inventors provided an ink provided as a solution of an alane N,N-dimethyl ethyl amine complex (e.g., an organometallic aluminum complex) dissolved in toluene (e.g., a solvent compatible with the Al precursor or Al source), and the substrates were glass substrates. The ink was spray deposited onto surfaces of the glass substrates that were heated to temperatures ranging from about 150° C. to about 200° C. under a nitrogen (N₂) atmosphere. The deposition was carried out in an inert atmosphere (e.g., a nitrogen atmosphere in this example) due to the reactivity of the organometallic aluminum complexes with oxygen. The precursor in the ink decomposed after printing onto the heated substrate at each of the temperatures examined. The metallization in each case was a gray, metallic film formed according to the following reaction:

H₃AlN(CH₃)₂(C₂H₅)—150 to 200° C.→Al+H₂+N(CH₃)₂(C₂H₅)

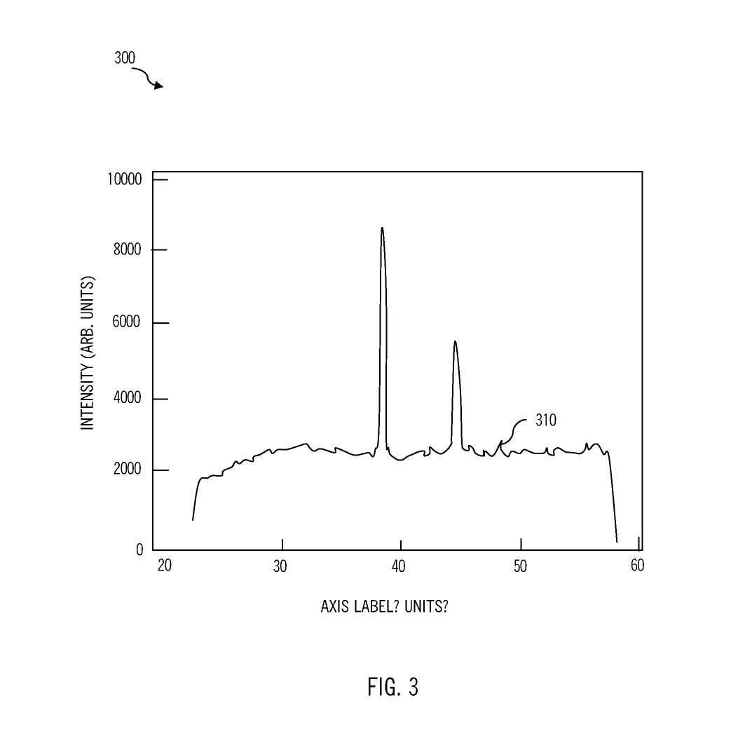

The resulting films were characterized by X-ray diffraction (XRD). FIG. 3 illustrates with graph 300 the values 310 of an XRD scan of one of these exemplary aluminum films deposited at about 200° C. using the organometallic ink as defined above for the test printing application. The graph 300 of the XRD scan shows that the printed film is Al metal with no other detectable phases present. Thus, the inventors have shown that Al metal films can successfully be deposited using ink formed from an organometallic aluminum complex and solvent that can be sprayed or printed at atmospheric or ambient pressure. Further, using known printing methods such as inkjet printing the Al metal film may be applied at a variety of thicknesses (e.g., 100 microns down to several nanometers or the like) and in a variety of patterns.

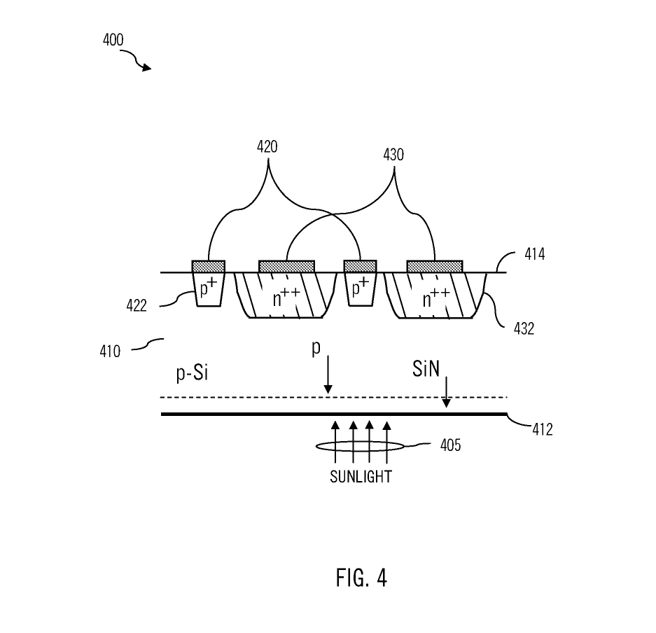

For example, the printing methods and inks described herein may be used to form any number of electronic devices or components such as contacts for solar cells and printed circuits. FIG. 4 illustrates an exemplary printed electronic device, i.e., a solar cell structure 400. The solar cell 400 may be implemented as a Si solar cell 400 with a silicon substrate 410 with an anti-reflective (AR) coating 412 with light 405 passing through the AR coating 405 to substrate 410.

On a surface 414 of the substrate 410 opposite the AR coating 412, the cell 400 includes a pair of contacts 420, 430. For example, the contact 420 may be the p contact and be formed by one of the printing/deposition methods described herein to be provided by direct writing of a pattern of aluminum. The contact 430 may be the n contact of the cell 400 and be formed using a direct writing technique before or after the forming of the contact 420. In one embodiment, the n contact is a metal layer printed in a pattern such as a silver thin film deposited according to the methods taught in U.S. Patent Publication No. 2008/0003364, which is incorporated herein by reference. In other embodiments, the n contact 430 is formed prior to printing the p contact 420, and the contact 430 in these cases may be formed using other processes such as screen printing, use of a paste layer, etching, and so on.

Typically, the cell 400 also includes a doped portion 422, 432 underneath each of the contacts 420, 430, and the doped portions 422, 432 may be a portion of the substrate 412 as shown or be a thin layer applied on the surface 414. The doping 422, 432 may be provided by a variety of methods known to those skilled in the art. For example, separate printing steps may be performed prior to the deposition of the contacts 420, 430 to provide doping 422, 432 in some cases while other embodiments may call for the ink used to apply the contacts 420, 430 to be modified to include the materials or precursors for obtaining desired p and n doping 422, 432 of substrate 410 underneath/adjacent the contacts 420, 430.

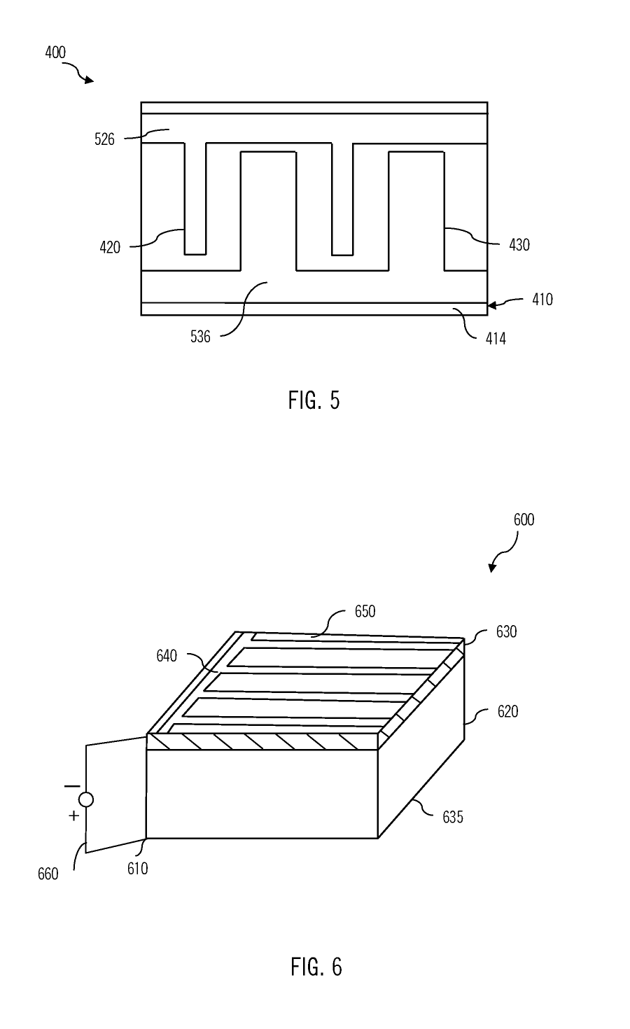

FIG. 5 provides a top view of the cell 400 showing the contact pattern on the surface 414 of the Si substrate 410. Due to the use of the printing processes described herein, the contacts 420, 430 can be printed upon a single surface 414, which is advantageous as it avoids issues with contacts on opposite sides of the substrate 410 such as blocking of sunlight 405. Further, direct write contacts 420, 430 can also be patterned as shown to be interdigitated contacts with lines or fingers that extend from bus bars 526, 536. The fingers of contacts 420, 430 extend generally parallel to each other with material from the differing contacts 420, 430 being intertwined or alternating (e.g., alternating lines of p and n contacts). The intricate pattern of cell 400 had previously been difficult to fabricate, but the use of inkjet or other direct write methods for forming contacts 420, 430 allows the designer of the cell 400 to select nearly any useful arrangement of the deposited metal (e.g., Al and Ag contacts or the like). Similarly, other intricate patterns may be provided such as printed circuits on flexible electronic substrates or the like.

In other cases, though, the printing techniques of writing Al layers/patterns may be used to provide an electrical device or component with an Al layer/pattern or thin film provided on one surface while connected contacts, circuits, or other electrical devices are provided on a different surface or location. Also, direct writing of Al may be used to provide layers of aluminum in more conventional devices such as front and rear contact solar cells. For example, FIG. 6 illustrates a solar cell 600 that differs from cell 500 in part because the contacts 610, 640 are provided on opposite sides of the cell 600. As shown, the cell 600 (which may be a Si solar cell structure for example) includes a rear metal contact 610 that may be printed using the methods described herein such as a pattern of aluminum (with lines extending from a bus bar or the like) or the contact 610 may be a layer that covers a cell substrate (e.g., a p-semiconductor layer) 620. In other words, the cell 600 shows an example of how the printing methods for Al may be used to provide layers of material without or with minimal patterning.

The cell 600 further includes an n-semiconductor layer 630 on the p-semiconductor layer 620 (or as a portion of this substrate) with a p-n junction 635 between these layers 620, 630. The layers 620, 630 may be provided by a wide variety of methods for fabricating solar cells, and since these methods are well documented, a detailed description of their growth or production is not provided in this document but will be understood by those skilled in the art. As shown, a contact 640 is provided upon the n-semiconductor layer 630, and the contact 640 may be formed of a layer of metal such as silver, copper, nickel, or the like, and the layer or film of contact 640 may be provided using vacuum deposition or other deposition techniques such as a direct write method (such as an ink printing method such as that shown in U.S. Patent Publication No. 2008/0003364 or the like). An AR film 650 (e.g., SiNₓ or other dielectric) is provided over the top/front contact 640. The two contacts 610, 640 are connected via consumer/power use circuit 660.

While a number of exemplary aspects and embodiments have been discussed above, those of skill in the art will recognize certain modifications, permutations, additions, and sub-combinations thereof It is therefore intended that the following appended claims and claims hereafter introduced are interpreted to include modifications, permutations, additions, and sub-combinations to the exemplary aspects and embodiments discussed above as are within their true spirit and scope. Printing of Al layers or patterns with an ink of an organometallic aluminum complex dissolved in solvent provides a number of advantages. The printing may be performed without the need for vacuum such as at ambient pressure or at atmospheric pressure rather than requiring a vacuum be maintained as in MOCVD and other vacuum deposition methods presently used for providing layers of aluminum. The use of the ink allows printing such as with inkjet printing, spray deposition, spin coating, stamping, and so on, which allows the aluminum film to be provided in nearly any predefined pattern and on the same surface or adjacent other components (e.g., interdigitated contacts with Al contacts provided adjacent other metallic contacts/components or other non-metallic components). The description stresses applications that include printing a contact on a solar cell (and, in some cases, alloying the Al contact to the silicon substrate) but there are many other applications in which the deposition of aluminum may be utilized and the receiving substrate may be nearly any material such as plastic, glass, ceramic, metal, and so on.

In one proposed embodiment, an inkjet printer is utilized for depositing the Al precursor ink as it provides a desirable alternative to vacuum deposition, screen printing, and electroplating. An advantage of using inkjet printing is that it is an atmospheric process capable of high resolution (e.g., features as small as 5 μm have been produced using an inkjet printer), and it is a non-contact, potentially 3D deposition process that makes it ideally suited to processing thin and fragile substrates such as solar cell substrates. In one application, an inkjet printer with a stationary drop-on-demand piezoelectric inkjet head from Microfab Technologies with a 50-micron orifice was utilized to print an Al pattern or metallization on a substrate. The substrate temperature was increased to a printing temperature in the range of 150 to 200° C. via a resistive substrate heater plate positioned on an X-Y stage (substrate platform) provided under the inkjet orifice/outlet, with the X-Y positioning accurately selectable (e.g., the substrate was moved to pattern the silver with positioning to the 1 μm). In an exemplary embodiment, the metal inks are inkjet printed on a substrate in an inert environment (e.g., nitrogen, argon, or other oxygen-free atmosphere), including heating the substrate to about 180° C. (a substrate surface temperature in the range of about 140 to about 300° C.) and then applying the metal ink through the inkjet orifice/outlet using a drop generation rate such as about 50 Hz (e.g., in the range of 25-100 Hz or the like). This embodiment results in a deposition rate of about 1 μm per pass. Thicker deposits or metallizations may be obtained by inkjet printing multiple layers. According to conductivity testing, the contact formation process can be better controlled and also results in conductor lines having higher conductivity then typically achieved with vacuum and other deposition techniques.

The composition of the inks described may be altered or tailored to suit a particular need such as by the inclusion of doping compounds and/or adhesion promoters to optimize/enhance mechanical and electrical properties of the subsequently processed Al contact or printed layer/component. For purposes of illustration, the metal ink may include components, such as dispersants, binders, and/or surfactants for enhancing deposition, resolution, and/or adhesion of the metal inks to the substrate. For example, the surface properties of the ink may be adjusted for higher printing resolution by adding surfactants such as alkyl sulfonate, alkyl phosphate and phosphonate, alkyl amine and ammonium, and the like. In addition, one or more process parameters may be adjusted for the particular metal ink being used to optimize the inkjet printing process and/or properties of the printed features. For example, the substrate temperature, gas flow rate, and/or application rate of the metal inks may be adjusted to optimize deposition rate of the metal ink, purity/phase of the deposited metal, and/or adhesion to the substrate. Or for example, the substrate temperature, gas flow rate, and/or application rate of the metal inks may be adjusted to optimize resolution, quality, thickness, conductivity and other electrical properties of the printed features.

The metal inks may be used for coating a substrate with metal (e.g., by spraying, dipping, and/or spinning techniques) and/or for producing metal features on a substrate (e.g., as lines, grids, or patterns) by inkjet printing or other direct-write deposition techniques. In addition, the metal inks may be used in a wide variety of different applications in addition to the shown solar cells. It is readily appreciated that applications of this technology may include, but are not limited to, printed circuit boards (PCBs), touch-screen display devices, organic light emitting diodes (OLEDs), cell phone displays, other photovoltaic devices, catalysts, decorative coatings, structural materials, optical devices, flexible electronics, and other electronic and micro-electronic devices.

1. A method of depositing a film of aluminum, comprising:
providing a substrate with a surface for receiving the aluminum film;
heating the surface of the substrate to a printing temperature; and
depositing a volume of ink upon the surface of the substrate, wherein the ink comprises an organometallic aluminum complex and wherein the printing temperature is selected to decompose the organometallic aluminum complex to the aluminum film and a gaseous byproduct.

2. The method of claim 1, wherein the printing temperature is greater than about 140° C.

3. The method of claim 1, wherein the substrate is positioned within an inert atmosphere and the depositing of the ink is performed within the inert atmosphere and at ambient pressure.

4. The method of claim 1, wherein the ink further comprises a solution of the organometallic aluminum complex and a solvent and wherein the ink has a viscosity of less than about 250 centipoise.

5. The method of claim 1, wherein the organometallic aluminum complex comprises an amine compound and alane.

6. The method of claim 1, wherein the organometallic aluminum complex comprises at least one aluminum compound selected from the group consisting of trimethylaluminum, triethylaluminum, tri-n-propylaluminum, tri-n-butylaluminum, tri-t-butylaluminum, triphenylaluminum, tribenzylaluminum, diethylaluminum hydride, diisobutylaluminum hydride, diphenylaluminum hydride, and monoamine complexes of these compounds.

7. The method of claim 1, wherein the depositing of the ink is performed using an inkjet printer, spin coating, spray deposition, or stamping.

8. The method of claim 1, wherein the substrate comprises a solar cell substrate and wherein the aluminum film comprises a contact for a solar cell.

9. The method of claim 8, further comprising printing an additional metal contact for the solar cell upon the surface of the substrate, wherein the aluminum contact and the additional metal contact are patterned as interdigitated contacts.

10. An aluminum deposition method, comprising:
positioning a substrate in an inert atmosphere;
heating a surface of the substrate to a temperature greater than about 140° C.;
providing a supply of ink comprising an aluminum precursor and a solvent; and
at atmospheric pressure, depositing a volume of the ink upon the heated substrate surface.

11. The method of claim 10, wherein the substrate comprises a silicon substrate for a solar cell and the volume ink is deposited in a pattern to provide a contact of the solar cell.

12. The method of claim 11, wherein the deposited ink decomposes to an aluminum metallization on the surface of the substrate and wherein the method further comprises after the depositing, processing the deposited ink to alloy the aluminum metallization to the silicon substrate.

13. The method of claim 11, wherein the contact pattern is an interdigitated pattern and the method further comprises applying another contact on the surface in an interdigitated pattern, whereby the contacts provide p and n contacts for the solar cell.

14. The method of claim 10, wherein the aluminum precursor comprises an organometallic aluminum complex comprising at least one of an amine compound and alane or an aluminum compound selected from the group consisting of trimethylaluminum, triethylaluminum, tri-n-propylaluminum, tri-n-butylaluminum, tri-t-butylaluminum, triphenylaluminum, tribenzylaluminum, diethylaluminum hydride, diisobutylaluminum hydride, diphenylaluminum hydride, and monoamine complexes of these compounds.

15. A direct write method for providing an aluminum metallization on an electronic component surface, comprising:
providing a printing assembly with a supply of an ink comprising an organometallic aluminum complex;
positioning the electronic component surface proximate to the printing assembly;
creating an inert atmosphere adjacent the electronic component surface; and
at a pressure of at least about 1 bar, operating the printing assembly to print a volume of the ink on the electronic component surface.

16. The method of claim 15, further comprising heating the electronic component surface to a temperature greater than about 150° C., wherein the organometallic aluminum complex decomposes to aluminum providing the aluminum metallization.

17. The method of claim 16, wherein the printing assembly comprises an inkjet and wherein the aluminum metallization is arranged in a pattern on the electronic component surface.

18. The method of claim 17, wherein the ink further comprises an organic solvent, the organometallic aluminum complex is provided in the organic solvent at less than about 50 weight percent, and the ink has a viscosity of less than about 250 centipoise.

19. The method of claim 15, wherein the organometallic aluminum complex comprises at least one of an amine compound and alane or an aluminum compound selected from the group consisting of trimethylaluminum, triethylaluminum, tri-n-propylaluminum, tri-n-butylaluminum, tri-t-butylaluminum, triphenylaluminum, tribenzylaluminum, diethylaluminum hydride, diisobutylaluminum hydride, diphenylaluminum hydride, and monoamine complexes of these compounds.

20. The method of claim 15, wherein the electronic component surface is a surface of a silicon substrate of a solar cell and wherein the volume of ink is arranged in an interdigitated pattern to define a contact for the solar cell.
